(19) United States
(12) Patent Application Publication
(10) Pub. No.: US 2006/0078724 A1
(43) Pub. Date: Apr. 13, 2006

(54) Hydrophobic surface with geometric roughness pattern

(76) Inventors: Bharat Bhushan, Powell, OH (US); Michael Nosonovsky, Kew Gardens, NY (US)

Correspondence Address: DINSMORE & SHOHL LLP;One Dayton Centre, Suite 1300, One South Main Street, Dayton, OH, 45402-2023, US

(21) Appl. No.: 11/094,867

(22) Filed: Mar. 31, 2005

Related U.S. Application Data
(60) Provisional application No. 60/616,956, filed on Oct. 7, 2004.

(51) Int. Cl. B32B 5/16

(52) U.S. Cl. 428/323

(57) ABSTRACT

A hydrophobic surface comprising a substrate and a roughened surface structure oriented on the substrate material is provided. The substrate comprises a surface, which is at least partially hydrophobic with a contact angle to liquid of 90° or greater. The roughened surface structure comprises a plurality of asperities arranged in a geometric pattern according to a roughness factor, wherein the roughness factor is characterized by a packing parameter p that equals the fraction of the surface area of the substrate covered by the asperities. The p parameter has a value from between about 0.5 to about 1.

### CROSS-REFERENCE TO RELATED APPLICATIONS

This application claims the benefit of U.S. Provisional Application Ser. No. 60/616,956, filed Oct. 7, 2004, and incorporates the application in its entirety.

### FIELD OF THE INVENTION

The present invention relates generally to a hydrophobic surface, and relates specifically to a roughened hydrophobic surface comprised of a plurality of asperities arranged in a geometric pattern.

### BACKGROUND OF THE INVENTION

It is well known that hydrophobicity may improve the mechanical properties of a surface. Rapid advances in nanotechnology, including such applications as micro/nanoelectromechanical systems (MEMS/NEMS) have stimulated development of new materials and design of hydrophobic surfaces. (Bhushan, B. et al, 1995, Nanotribology: Friction, Wear and Lubrication at the Atomic Scale, Nature, Vol. 374, pp. 607-616; Bhushan, B., 1998, Tribology Issues and Opportunities in MEMS, Kluwer Academic Publishers, Dordrecht, Netherlands; Bhushan, B., 2004, Springer Handbook of Nanotechnology, Springer-Verlag, Heidelberg, Germany). In MEMS/NEMS, surface to volume ratio grows with miniaturization, and surface phenomena dominate. One of the crucial surface properties for materials in micro/nanoscale applications is non-wetting or hydrophobicity. Creating hydrophobic surfaces on materials, such as glass windows, are desirable in some applications, because these surfaces cause water to flow away from the surface, thereby preventing the buildup of liquid on the surface. On the other hand, wetting results in formation of menisci at the interface between solid bodies during sliding contact, which increases adhesion/friction. As a result of this, frictional forces on the wetted surface are greater than those on the dry surface, which is usually undesirable (Bhushan, B., 1999, Principles and Applications of Tribology, Wiley, NY; Bhushan, B., 2002, Introduction to Tribology, Wiley, NY). Hydrophobic surfaces are also desirable due to their self-cleaning properties. These surfaces repel liquids, thereby resulting in liquid and contaminating particles flowing away from the surface.

Wetting is characterized by a contact angle, which is defined as the angle between the solid and liquid surfaces. If a liquid wets the surface, the value of the contact angle is 90° or less (referred to as wetting liquid), whereas if the liquid does not wet the surface (referred to as non-wetting liquid or hydrophobic surface), the value of the contact angle ranges between 90° and 180°. A surface is considered superhydrophobic, if the contact angle has a range of between about 150° to 180°. The contact angle depends on several factors, such as surface roughness, the manner of surface preparation, and the cleanliness of the surface. (Adamson A. V, 1990, Physical Chemistry of Surfaces, Wiley, NY; Israelachvili, J. N., 1992, Intermolecular and Surface Forces, 2nd edition, Academic Press, London; Bhushan, 1999, 2002). One of the ways to increase the hydrophobic properties of the surface is to increase surface roughness. Wenzel developed a model that is based on consideration of net energy decrease during spreading of a liquid droplet on a rough surface. Wenzel, R. N., 1936, “Resistance of Solid Surfaces to Wetting by Water,” Indust. Eng. Chem., Vol. 28, pp. 988-994. The Wenzel model, which has been experimentally proven, demonstrates that a rough surface with a larger solid-liquid interface area, leads to larger net energy and a larger contact angle. An alternative model was developed by Cassie and Baxter, who considered a composite solid- liquid-air interface, which may be formed for very rough surfaces, due to possible formation of cavities. Cassie, A. and Baxter, S, 1944, “Wettability of Porous Surfaces,” Trans. Faraday Soc., Vol. 40, pp. 546-55

Biomimetics has also played a role in the development of new surfaces. Biomimetics, which comes from a Greek word “biomimesis” meaning to mimic life, describes the study and simulation of biological objects with desired properties. To that end, scientists have studied natural surfaces that are extremely hydrophobic, in order to reproduce these properties on artificial surfaces. Among these surfaces studied, as shown in FIGS. 1a and 1b, are leaves of water-repellent plants such as Nelumbo nucifera (lotus) and Colocasia esculenta, which have high contact angles with water (Barthlott, W. et al, 1997, “Characterization and Distribution of Water-Repellent, Self-Cleaning Plant Surfaces,” Annals of Botany, Vol. 79, pp. 667-677; Wagner, P. et al, 2003, “Quantitative Assessment to the Structural Basis of Water Repellency in Natural and Technical Surfaces” J. Exper. Botany, Vol. 54, No. 385, pp. 1295-1303.) At least two surface characteristics are believed to produce water repellent properties on these surfaces. First, the surface of the leaves is usually covered with a range of different waxes made from a mixture of large hydrocarbon molecules, measuring about 1 nm in diameter, that are strongly hydrophobic. Second, the surface is very rough due to so-called papillose epidermal cells, which form asperities or papillae. The surface of the lotus leaf generally has pyramid shaped asperities that are spaced a few μm from one pyramid tip to another pyramid tip. Drops of water substantially contact only the tips or peaks of the pyramids so that the contact area of water to surface is minuscule relative to water drops contacting a micro smooth surface. The reduced contact surface area results in a very low adhesion between the water drops and the micro-rough surface. Other examples of hydrophobic biological surfaces include duck feathers and butterfly wings. Their corrugated surfaces provide air pockets that prevent water from completely touching their surfaces. The interface between the air pockets, the asperities, and the liquid contacting the surface is called the composite solid-liquid-air interface.

Several patents have disclosed rough hydrophobic surfaces. U.S. Pat. No. 3,354,022 discloses water repellent surfaces having a micro-rough structure with elevations and depressions and a hydrophobic material. In particular, a fluorine containing polymer is disclosed as the hydrophobic material. According to one embodiment, a surface with a self-cleaning effect can be applied to ceramic brick or glass by coating the substrate with a suspension comprising glass beads and a fluorocarbon wax. The beads have a diameter in the range of from 3 to 12 μm.

Baumann, U.S. Application No. 2003/0152780 discloses a self-cleaning surface with a micro-rough structure consisting of elevations and depressions in a geometrical or a preferably random arrangement. The invention describes an aspect ratio, which equals the mean profile height of the elevation divided by the mean distance between adjacent elevation tips. The disclosed aspect ratio range from 0.3 to 10.

Barthlott, U.S. Pat. No. 6,660,363 discloses a self-cleaning surface consisting of an artificial surface structure of elevations and depressions wherein the distances between the asperities are in the range of from 5 to 200 μm, and the heights of the elevations are in the range of from 5 to 100 μm. The elevations consist of hydrophobic polymers or permanently hydrophobized materials.

Baumann, U.S. Pat. No. 6,800,345 discloses a coated substrate, wherein the coating comprises nanoscale structure-forming particles, microscale structure-forming particles, and an inorganic or organic layer-forming material that binds the structure-forming particles to the substrate. The nanoscale structure-forming particles have an average diameter of less than 100 nm. The micro-scale structure-forming particles have an average diameter in a range of from about 0.1 micrometers to about 50 micrometers, and are contained in a same first layer as the nanoscale particles, or in an optional second layer that is disposed underneath the first layer. The micro-scale structure-forming particles support the nanoscale structure-forming particles that are disposed thereon.

Although roughness reduces wetting by increasing hydrophobicity, some rough surfaces may also contain defects, which increase wetting. Roughened surfaces affect the contact angle by increasing the solid-liquid contact area and by adding sharp edges. A larger solid-liquid contact area may increase the possibility of destabilization of the composite solid-liquid-air interface. In these cases, the solid-liquid-air interface can easily be destabilized due to imperfections in the profile shape or due to dynamic effects, such as surface waves. Moreover, a sharp edge can pin the composite solid-liquid-air interface (also known as the “triple line”) at a position away from stable equilibrium.

As additional hydrophobic surfaces of varying size, capability, and cost are developed, the need arises for improved hydrophobic surfaces and improvements in components thereof, including roughened hydrophobic surfaces, and specifically roughened hydrophobic surfaces optimized to maximize contact angle and minimize defects such as the pinning of a composite interface at a non-equilibrium position, and the destabilization of the composite interface.

### SUMMARY OF THE INVENTION

According to embodiments of the present invention, a hydrophobic surface comprising a substrate and a roughened surface structure oriented on the substrate material is provided. The substrate comprises a surface, which is at least partially hydrophobic with a contact angle to liquid of 90° or greater. The roughened surface structure comprises a plurality of asperities arranged in a geometric pattern according to a roughness factor, wherein the roughness factor is characterized by a packing parameterp that equals the fraction of the surface area of the substrate covered by the asperities. The parameter p has a value from between about 0.5 to about 1.

These and additional features and advantages provided by the hydrophobic surface embodiments of the present invention will be more fully understood in view of the following detailed description, the accompanying drawings, and the appended claims.

### BRIEF DESCRIPTION OF THE DRAWINGS

Reference will now be made by way of example to the drawings in which:

FIG. 1a is a Scanning Electron Microscope (SEM) image illustrating papillae on water-repellent plant leaves of a Colocasia esculenta plant.

FIG. 1b is an SEM image illustrating papillae on water-repellent plant leaves of a Nelumbo nucfera (lotus) plant.

FIG. 1c is an SEM image illustrating a distribution of the papillae on the colocasia esculenta leaf surface according to one or more embodiments of the present invention.

FIG. 2a is a schematic illustration of the contact angle θ for a droplet of liquid contacting a smooth surface.

FIG. 2b is a schematic illustration of the contact angle θ for a droplet of liquid contacting a roughened surface according to one or more embodiments of the present invention.

FIG. 2c is a schematic illustration of the contact angle θ for a droplet of liquid contacting a surface with sharp edges according to one or more embodiments of the present invention.

FIG. 3 is a graphical illustration of the relationship between the roughness factor R_{f} and the contact angle θ according to one or more embodiments of the present invention.

FIG. 4a is a schematic illustration of the formation of a composite solid-liquid-air interface of a sawtooth profile according to one or more embodiments of the present invention.

FIG. 4b is a schematic illustration of the formation of a composite solid-liquid-air interface of a smooth profile according to one or more embodiments of the present invention.

FIG. 4c is a schematic illustration of the destabilization of a composite solid-liquid-air interface for a sawtooth profile according to one or more embodiments of the present invention.

FIG. 4d is a schematic illustration of the destabilization of a composite solid-liquid-air interface for a smooth profile according to one or more embodiments of the present invention.

FIG. 5a is a schematic illustration of a roughened surface with rectangular asperities according to one or more embodiments of the present invention.

FIG. 5b is a schematic illustration of a roughened surface with a cylindrical foundation and a hemispheric peak according to one or more embodiments of the present invention.

FIG. 5c is a schematic illustration of a roughened surface with pyramidal or conical asperities according to one or more embodiments of the present invention.

FIG. 6a is a graphical illustration of the relationship between the contact angle θ and a packing parameter p of a roughened surface with rectangular asperities and hemispherically topped cylindrical asperities according to one or more embodiments of the present invention.

FIG. 6b is a graphical illustration of the relationship between the contact angle θ and a packing parameter p of a roughened surface with conical or pyramidal asperities according to one or more embodiments of the present invention.

FIG. 7 is a schematic illustration of a hexagonal packing pattern of circular asperities according to one or more embodiments of the present invention.

FIG. 8a is a schematic illustration of a packing arrangement for cylindrical asperities with hemispherical peaks according to one or more embodiments of the present invention.

FIG. 8b is a schematic illustration of a packing arrangement for pyramidal asperities with hemispherical peaks according to one or more embodiments of the present invention.

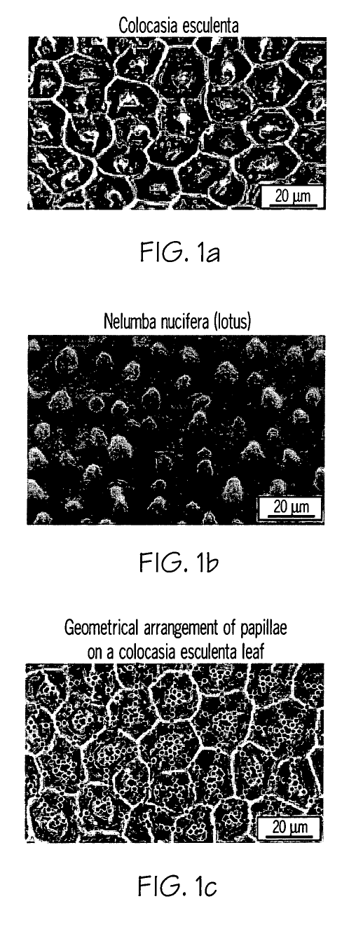

### DETAILED DESCRIPTION

Embodiments of the present invention relate to hydrophobic surfaces adapted to repel liquid contacting the surface. The hydrophobic surface comprises a substrate, which is at least partially hydrophobic. Due to its hydrophobicity, the substrate has a contact angle to liquid of 90° or greater. The substrate may comprise a hydrophobic material, or may comprise a hydrophilic material with a hydrophobic film applied thereon. The hydrophobic surface also comprises a roughened surface structure oriented on the substrate material. The roughened surface structure comprises a plurality of asperities, or elevations, arranged in a geometric pattern according to a roughness factor. Typically, the asperities have a maximum height of about 100 μm. The roughness factor is a mathematical algorithm characterized by a packing parameter p that equals the fraction of the surface area of the substrate covered by the asperities of the roughened surface structure. The packing parameter p has a value from between about 0.5 to about 1.

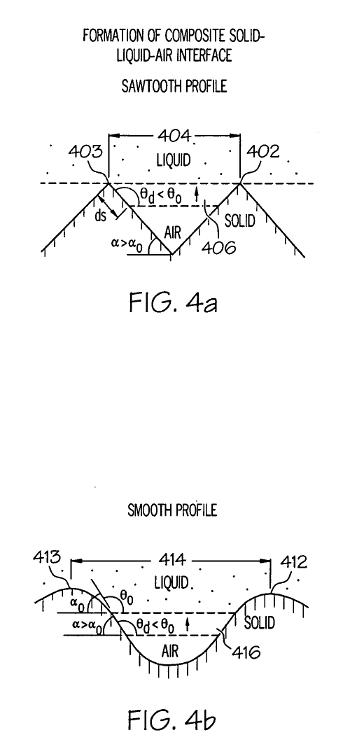

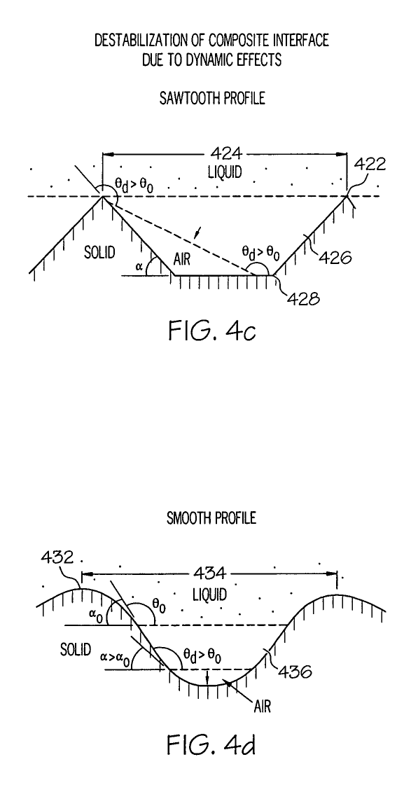

Referring to FIGS. 4a and 4b, the formation of a composite solid-liquid-air interface on a hydrophobic surface is provided. FIG. 4a illustrates the formation of a composite solid-liquid-air interface for hydrophobic surfaces with a sawtooth roughness profile and FIG. 4b illustrates a hydrophobic surface with a curved sinusoidal profile. As shown, air pockets are formed between adjacent asperities 402,403. The combination of air pockets, adjacent asperities, and a contacting liquid forms a solid-liquid-air interface location on the roughened surface. These air pockets prevent liquid from flowing into the cavities between the asperities, and thereby contacting the surface.

In accordance with one embodiment as shown in FIG. 4a, the spacing 404 between asperity peaks 402, is configured to provide a stable solid-liquid-air interface. Referring to FIG. 4c, the distance 424 between these peaks 422 may cause destabilization of the composite solid-liquid-air interface, because a large distance 424 between asperities affects the contact angle thereby causing the liquid to advance and wet a portion 428 of the surface.

As the Wenzel model states, a rough surface leads to larger net energy and a larger contact angle. It is well known that the surface atoms or molecules of liquids or solids have energy above that of similar atoms and molecules in the interior, which results in surface tension or free surface energy being an important surface property. This property is characterized quantitatively by the surface tension or free surface energy γ, which is equal to the work that is required to create a unit area of the surface at constant volume and temperature. The units of γ are J/m² or N/m and γ can be interpreted either as energy per unit surface area or as tension force per unit length of a line at the surface. When a solid (S) is in contact with liquid (L), the molecular attraction will reduce the energy of the system below that for the two separated surfaces. This may be expressed by the Dupré equation,
W_{SL}=γ_{SA}+γ_{LA}−γ_{SL} (1)
where W_{SL} is the work of adhesion per unit area between two surfaces, γ_{SA} and γ_{SL} are the surface energies (surface tensions) of the solid against air and liquid, and γ_{LA} is the surface energy (surface tension) of liquid against air (Israelachvili, 1992; Bhushan, 1999).

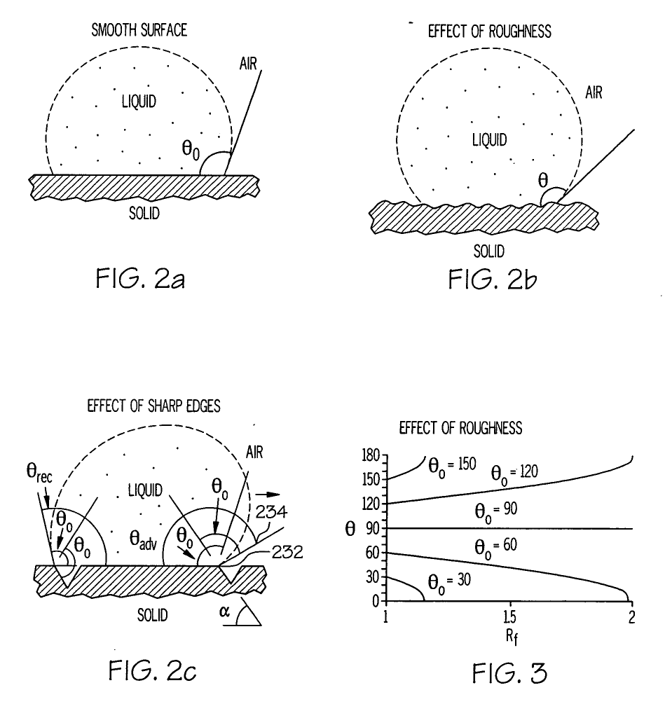

If a droplet of liquid is placed on a solid surface, the liquid and solid surfaces come together under equilibrium at a characteristic angle called the static contact angle θ₀, as shown in FIGS. 2a, 2b, and 2c. The contact angle can be determined from the condition of the total energy of the system being minimized (Adamson, 1990; Israelachvili, 1992). The total energy Eₜₒₜ is given by
Eₜₒₜ=γ_{LA}(A_{LA}+A_{SL})−W_{SL}A_{SL} (2)
where A_{LA} and A_{SL} are the contact areas of the liquid with the air, and the solid with the liquid, respectively. It is assumed that the droplet is small enough so that the gravitational potential energy can be neglected. When the equilibrium dEₜₒₜ=0,
γ_{LA}(dA_{LA}+DA_{SL})−W_{SL}dA_{SL}=0 (3)
For a droplet of constant volume, it may be shown using geometrical considerations, that
dA_{LA}/dA_{SL}=cos θ₀ (4)

Combining (1), (3), (4) yields Young's equation for the contact angle,

$$cos {θ}_{0} = \frac{{γ}_{SA} - {γ}_{SL}}{{γ}_{LA}} \qquad ( 5 )$$

which provides the static contact angle θ₀ for given surface tensions. Young's equation is valid only for flat solid surfaces, such as that shown in FIG. 2a.

For the case of a droplet upon a rough surface as in FIG. 2b, Eq. (4) is modified to yield the following equation (Wenzel, 1936):

$$cos θ = ⅆ {A}_{LA} / ⅆ {A}_{F} = \frac{{A}_{SL}}{{A}_{F}} ⅆ {A}_{LA} / ⅆ {A}_{SL} = Rf cos {θ}_{0} \qquad ( 6 )$$

where θ is the contact angle for rough surface, A_{F} is the flat solid-liquid contact area or a projection of the solid-liquid area A_{SL} on the horizontal plane, and R_{f} is a roughness factor defined by the equation
R_{f}=A_{SL}/A_{F} (7)

As shown in Eq. (6), if the liquid wets a flat surface (cos θ₀>0), it will also wet the rough surface with a contact angle of θ<θ₀, since A_{SL}/A_{F}>1. Furthermore, for non-wetting liquids (cos θ₀<0), the contact angle with a rough surface will be greater than that with the flat surface, θ>θ₀. The dependence of the contact angle on the roughness factor is shown in FIG. 3 for different values of θ₀.

It is noted that the Eq. (6) is most applicable for moderate values of Rf, when −1≦R_{f} cos θ₀≦1. For high roughness, a wetting liquid will be completely absorbed by the rough surface cavities. However, a non-wetting liquid cannot penetrate into surface cavities with slopes sufficient to form air pockets, which may result a composite solid-liquid-air interface, as shown for the sawtooth and smooth profiles in FIGS. 4a and 4b. The solid-liquid contact zones are typically located at the peaks of the asperities, whereas the air pockets and solid-air contact zones are typically located in the cavities between the peaks.

Referring to FIGS. 4a and 4b, the formation of the composite interface is shown for a sawtooth profile with slope α and a smooth (sinusoidal) profile. In order to determine, whether the interface is solid-liquid or composite, the change of net energy dEₜₒₜ should be considered, which corresponds to the displacement ds of the liquid-air surface along the inclined groove wall as shown in FIG. 2a. For the solid-liquid interface, dEₜₒₜ<0, therefore it is more energetically profitable for the liquid to advance and fill the groove, whereas for the composite interface, dEₜₒₜ>0, it is more energetically profitable for the liquid to recede and leave the groove. The change of energy depends on slope α. The critical value of the slope, α₀, can be found by setting dEₜₒₜ=0,

$${dE}_{tot} = {dA}_{SLγSL} + {dA}_{LAγLA} + {dA}_{LAγLA} = - 2 ds cos {α}_{0} ds + 2 ds ( {γ}_{SL} - {γ}_{SA} ) = 2 γ LA cos {α}_{0} ds + 2 ( {γ}_{SL} - {γ}_{SA} ) ds \qquad ( 8 )$$

Combining (5) and (8) yields cos α₀=−cos θ₀ or
α₀=180°−θ₀ (9)
For slopes where α<α₀, and dEₜₒₜ<0, the interface is solid-liquid, whereas for slopes where α>α₀, and dEₜₒₜ>0, the interface is composite, as shown in FIGS. 4a and 4b. For a profile of arbitrary smooth shape as in FIG. 2b, a composite interface is possible if the slope exceeds the critical value α₀ at some point. In this case, the liquid would recede and leave space in the groove between asperities, as shown in FIG. 4b for a smooth profile.

Referring to FIG. 4c, the liquid-air interface 426 may be destabilized due to imperfectness of the profile shape or due to dynamic effects, such as surface waves. This may result in formation of the solid-liquid interface 428 for a sawtooth profile with a distance 424 between the asperity peaks as in FIG. 4c, and for a smooth profile as in FIG. 4d. The liquid advances, if the liquid-air interface 426 reaches a position at which its local angle θ_{d} with the solid surface is greater than θ₀.

In accordance with another embodiment, a hydrophobic surface configured to prevent the pinning of the solid-liquid-air interface at a non-equilibrium position is provided. The roughened surface may comprise rounded peaks, thereby substantially reducing the presence of sharp edges in the roughness profile. The rounded peaks prevent the composite solid-liquid-air interface from being pinned at a non-equilibrium position. A sharp edge 232 can pin the line of contact of the solid, liquid, and air (also known as the “triple line”) at a position away from stable equilibrium, i.e. at contact angles different from θ₀. This effect is illustrated in FIG. 2c, which shows a droplet, propagating along a solid surface with grooves. At the edge point 232, the contact angle is not defined and can have any value between the values corresponding to the contact with the horizontal and inclined surfaces. For a droplet moving from left to right in FIG. 2c, the triple line will be pinned at the edge point until it is able to proceed to the inclined plane 234. As can be observed in FIG. 2c, the change of the surface slope (α) at the edge 232 is the reason, which causes the pinning. Because of the pinning, the value of the contact angle at the front of the droplet (dynamic advancing contact angle or θ_{adv}=θ₀30 α) is greater than θ₀, whereas the value of the contact angle at the back of the droplet (dynamic receding contact angle or θ_{rec}=θ₀−α) is smaller than θ₀. This phenomenon is known as the contact angle hysteresis (Israelachvili, 1992; Eustathopoulos N., Nicholas, M. G., Drevet, B., 1999, Wettability at High Temparatures, Pergamon, Amsterdam). The hysteresis domain is the range defined by the difference θ_{adv}−θ_{rec}. The liquid can more effectively travel along the surface if the contact angle hysteresis is small. To combat pinning, hemispherical peaks or other suitable rounded peak surfaces may be utilized to substantially reduce pinning.

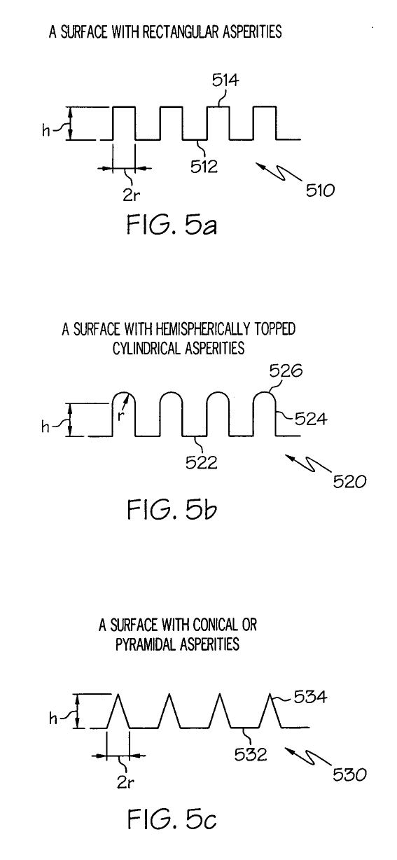

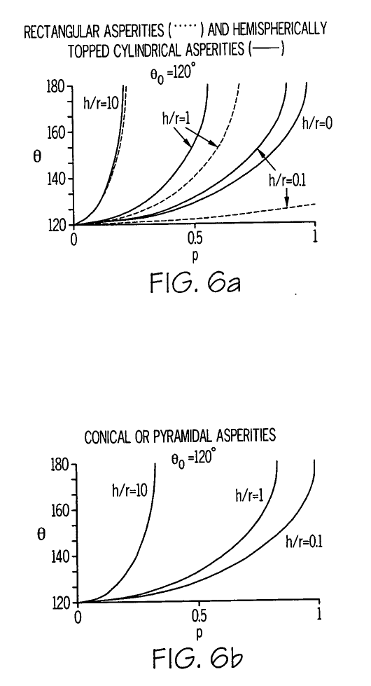

According to one embodiment as shown in FIG. 5a, a hydrophobic surface 510 with a hydrophobic substrate 512 and a roughened surface comprising rectangular shaped asperities 514 is provided. The rectangular asperities are arranged on the hydrophobic substrate 512 according to a roughness profile, R_{f}=1+2p²h/r. The rectangular shaped asperities 514 comprise a height h, a length of a side 2r, and a packing parameter p=2r\sqrt{η}, where η is the density of asperities per unit area. The length of the side 2r, which is the length of the base or foundation of the asperity 514, may also be called the foundation radius.

The roughness factor for the rectangular asperities 514 may be obtained as follows. As stated in Eq. (7), the general equation for roughness is

$${R}_{f} = \frac{{A}_{SL}}{{A}_{F}}$$

where A_{SL} is the solid-liquid contact area, and A_{F} is the flat solid-liquid contact area. A_{F} may be considered the projection of the solid-liquid area A_{SL} on the horizontal plane. The surface area of the asperities, A_{ASP}=8rh²+4r², and the flat projection area is 4r². With a random distribution of asperities throughout a surface with a density of η asperities per unit area
A_{SL}=A_{F}+A_{F}η(8rh+4r²)−A_{F}4ηr²=A_{F}(1+8ηrh) (10)
Combining this value for A_{SL} into the roughness equation yields
R_{F}=1+8ηrh=1+2p²h/r (11)
wherein the packing parameter, p=2r\sqrt{η}.

According to another embodiment as shown in FIG. 5b, a hydrophobic surface 520 with a hydrophobic substrate 522 and a roughened surface comprising a cylindrical foundation 524 and a hemispheric peak 526 is provided. The cylindrical asperities 524 with hemispheric peaks 526 are arranged on the hydrophobic substrate 522 according to a roughness profile, R_{f}=1+p²(1+2h/r). These asperities 524 comprise a height h, a hemispherical peak of radius r, and a packing parameter p=r\sqrt{πη}, where η is the density of asperities per unit area.

The roughness factor for the cylindrical asperities 524 with hemispherical peaks 526 may be obtained as follows. The surface area of these asperities is A_{ASP}=2πr²(1+h/r), and the flat projection area is πr². With a random distribution of asperities throughout a surface with a density of η asperities per unit area,
A_{SL}=A_{F}+A_{F}η2πr²(1+h/r)−A_{F}ηπr²=A_{F}[1+nπr²(1+2h/r)]. (12)
Combining this value for A_{SL} into the roughness equation yields
R_{F}=1+nπr²(1+2h/r)=1+p²(1+2h/r) (13)
wherein the packing parameter, p=r\sqrt{πη}.

According to yet another embodiment as shown in FIG. 5c, a hydrophobic surface 530 with a hydrophobic substrate 532 and a roughened surface comprising conical asperities 534 is provided. The conical asperities 534 are arranged on the hydrophobic substrate 532 according to a roughness profile, R_{f}=1+p²\sqrt{1+(h/r)²}. These asperities 534 comprise a height h, a radius r, a side length L=\sqrt{h²+r²}, and a packing parameter p=r\sqrt{πη}, where η is the density of asperities per unit area.

The roughness factor for the conical asperities 534 may be obtained as follows. The surface area of these asperities is A_{ASP}=πr²(1+L/r). With a random distribution of asperities throughout a surface with a density of η asperities per unit area
A_{SL}=A_{F}+A_{F}ηπr²(1+L/r)−A_{F}ηπr²=A_{F}(1+ηπrL)=A_{F}(1+nπr² {square root over (1+(h/r)})²) (14)
Combining this value for A_{SL} into the roughness equation yields
R_{F}=1+nπr² {square root over (1+(h/r)})²=1+p² \sqrt{1+(h/r)²} (15)
wherein the packing parameter, p=r\sqrt{πη}.

According to another embodiment as shown in FIG. 5c, a hydrophobic surface 530 with a hydrophobic substrate 532 and a roughened surface comprising pyramidal asperities 534 is provided. The pyramidal asperities 534 are arranged on the hydrophobic substrate 532 according to a roughness profile, R_{f}=1+p² \sqrt{1+(h/r)²}. These asperities 534 comprise a square foundation of width 2α and height h, and a packing parameter p=2r\sqrt{η}, where η is the density of asperities per unit area.

The roughness factor for the pyramidal asperities 534 may be obtained as follows. The surface area of these asperities is A_{ASP}=4r²(1+\sqrt{1+(h/r)²}). With a random distribution of asperities throughout a surface with a density of η asperities per unit area
A_{SL}=A_{F}+4A_{F}ηr²(1+\sqrt{1+(h/r)²})−4A_{F}ηr²=A_{F}(1+4nr² \sqrt{1+(h/r)}²). (16)
Combining this value for A_{SL} into the roughness equation yields
R_{F}=1+4nr² {square root over (1+(h/r)})²=1+p² \sqrt{1+(h/r)²} (17)
wherein the packing parameter, p=2r\sqrt{η}.

In accordance with one or more embodiments of the present invention as shown in Eqs. 11, 13, 15, and 17, and in FIGS. 6b, and 6c, the maximum contact angle θ can be achieved by increasing the aspect ratio h/r and the packing parameter p. Preferably, the aspect ratio has a value of from between about 0.1 to about 10, wherein the contact angle increases as the aspect ratio increases. Increasing the maximum aspect ratio is typically achieved by increasing asperity height, but decreasing the foundation radius may also increase the aspect ratio. Generally, the maximum packing parameter may be achieved by packing the asperities as tight as possible. The square of the packing parameter p² is equal to ratio of the foundation area of the asperities to the total surface area. Therefore, the higher value of p corresponds to higher packing density. Numerous packing arrangements are suitable, so long as p ranges from between about 0.5 to about 1.

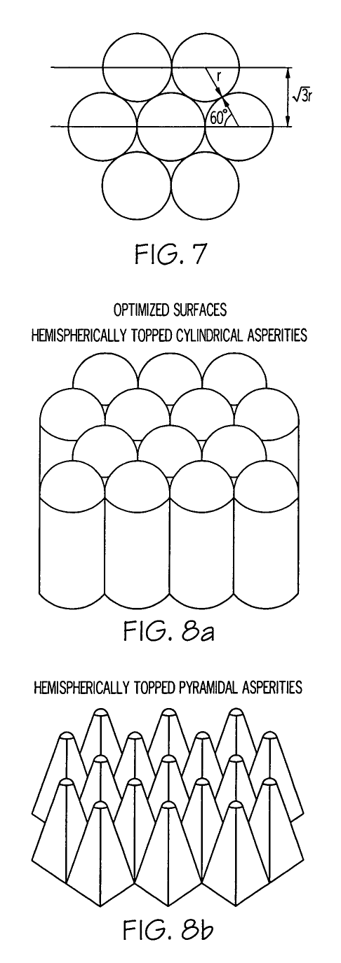

For example; asperities with a circular foundation arranged in a square pattern results in packing of 1/(2r) rows per unit area with 1/(2r) asperities per unit length in the row. In another embodiment as shown in FIGS. 7 and 8a, the asperities may be oriented in a hexagonal packed arrangement. In a specific embodiment, the hexagonal packed arrangement has a packing parameter p in the range of from between about 0.8 to about 1. For example, hexagonal distribution pattern results of asperities may result in packing of 1/(\sqrt{3r}) rows of asperities per unit length with 1/(2r) asperities per unit length in the row, or =1/(2\sqrt{3r²}), which yields

$$p = r \sqrt{π η} = \sqrt{\frac{π}{2 \sqrt{3}}} \approx 0.952$$

An alternative packing arrangement embodiment, which may provide a packing density of about p=1, is given by pyramidal asperities with a square foundation. In order to avoid pinning due to sharp edges, the asperities may comprise rounded peaks, according to another embodiment of the present invention as shown in FIG. 8b. For example, a rounded hemispheric peak may substantially reduce the possibility of pinning the solid-liquid-air interface at a non-equilibrium position.

According to another embodiment, the foundational radius of the asperities is configured to be less than the radius of a drop of liquid contacting the surface. The foundational radius of individual asperities, r (for circular foundation) or foundation side length 2r (for square foundation), should be small as compared to typical droplets. The upper limit of droplet size may be estimated based on the requirement that the gravity effect is small compared to the surface tension (a bigger droplet is likely to be divided into several small droplets). The gravitational energy of the droplet is given by its density ρ, multiplied by the volume, gravitational constant g =9.81 m/s², and radius,

$${W}_{g} = \frac{4}{3} π {r}^{3} ρ g {r}_{,}$$

whereas the energy due to the surface tension can be estimated by droplet surface area multiplied by the surface tension W_{g}=4ηr²γ_{LA}. Based on W_{g}<<Wₛ, maximum droplet radius may be estimated as

$${r}_{max} << \sqrt{\frac{3 {γ}_{LA}}{ρ g}} \qquad ( 18 )$$

Typical quantities for water where, ρ=1000 kg/m³ and γ_{LA}=72 rnJ/m², result in rₘₐₓ<<4.7 mm. Although the small droplets will tend to unite into bigger ones, the minimum droplet radius is limited only by molecular scale, so it is preferable to have r as small as possible.

The geometric roughness profiles provided are only a few of numerous roughness profiles that may be used. Other geometric roughness profiles are contemplated under the present invention. Moreover, one of ordinary skill would know that various combinations of geometric profiles, packing parameters, aspect ratios, etc are also within the scope of the present invention.

A roughened hydrophobic surface may be created by various suitable methods known to one of ordinary skill in the art. Some of the many methods suitable for forming the structures include etching and embossing processes, coating processes, shaping processes using appropriately structured molds, polishing processes, photolithography, solvent or vapor deposition, electroplating, electrowetting, plasma processing, warm-water processing, and high temperature sintering. The surface may comprise coatings, which include glass, metal, and other materials capable of forming asperities on the substrate surface.

For hydrophilic substrates, the substrate may be converted into a roughened hydrophobic surface in two steps. First, the hydrophilic substrate may be made hydrophobic by adding a hydrophobic material, such as a film, waxes or gels to the substrate. A substrate material, such as glass, may also undergo silanization to provide a hydrophobic surface on a hydrophilic substrate. Other coatings and/or depositions comprising materials, such as metal oxides, polytetrafluoroethylene, or silicon, are also contemplated. After the surface has been made hydrophobic, the surface may be roughened by any of the above suitable roughening methods.

It is noted that terms like “specifically,” “preferably,” “typically”, and “often” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described the invention in detail and by reference to specific embodiments thereof, it will be apparent that modifications and variations are possible without departing from the spirit and scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A hydrophobic surface comprising:
a substrate wherein a surface of the substrate is at least partially hydrophobic with a contact angle to liquid of 90° or greater; and
a roughened surface structure oriented on the substrate material, wherein the roughened surface structure comprises a plurality of asperities arranged in a geometric pattern according to a roughness factor, the roughness factor characterized by a packing parameterp that equals the fraction of the surface area of the substrate covered by the asperities, wherein p has a value of from between about 0.5 to about 1.

2. A hydrophobic surface as in claim 1 wherein the substrate comprises a hydrophilic base layer and a hydrophobic film on the hydrophilic base layer.

3. A hydrophobic surface as in claim 1 further comprising air pockets formed between adjacent asperities, wherein a combination of air pockets, adjacent asperities, and a contacting liquid forms a composite solid-liquid-air interface location on the roughened surface.

4. A hydrophobic surface as in claim 1 wherein the asperities comprise rounded peaks configured to prevent the pinning of the solid-liquid-air interface at a non-equilibrium position.

5. A hydrophobic surface as in claim 1 wherein the spacing between asperity peaks is configured to provide a stable solid-liquid-air interface.

6. A hydrophobic surface as in claim 1 wherein the roughened surface comprises rectangular shaped asperities.

7. A hydrophobic surface as in claim 6 wherein the rectangular shaped asperities comprise a height h, a length of a side 2r, and a roughness factor R_{f} wherein R_{f}=1+2p²h/r, and wherein p=2r\sqrt{η}, wherein η is the density of asperities per unit area.

8. A hydrophobic surface as in claim 1 wherein the roughened surface comprises asperities with a cylindrical foundation and a hemispheric peak.

9. A hydrophobic surface as in claim 8 wherein the asperities comprise a cylindrical foundation having a height h, a hemispherical peak of radius r, and a roughness factor R_{f} wherein R_{f}=1+p²(1+2h/r) and p=r\sqrt{πη}, wherein η is the density of asperities per unit area.

10. A hydrophobic surface as in claim 9 wherein the asperities are oriented in a hexagonal packed arrangement, the hexagonal packed arrangement having a p in the range of from between about 0.8 to about 1.

11. A hydrophobic surface as in claim 1 wherein the roughened surface comprises conical asperities.

12. A hydrophobic surface as in claim 11 wherein the conical asperities comprise a height h, a radius r, a side length L=\sqrt{h²+r²}, and a roughness factor R_{f} wherein
R_{f}=1+p² \sqrt{1+(h/r)²} and p=r\sqrt{πη}, wherein η is the density of asperities per unit area.

13. A hydrophobic surface as in claim 1 wherein the roughened surface comprises pyramidal asperities.

14. A hydrophobic surface as in claim 13 wherein the asperities comprise a width 2a, a height h, and a roughness factor R_{f} wherein R_{f}=1+p² \sqrt{1+(h/r)²}, and p=2r\sqrt{η}, wherein η is the density of asperities per unit area.

15. A hydrophobic surface as in claim 14 wherein the pyramidal asperities comprise a rounded hemispheric peak.

16. A hydrophobic surface as in claim 14 wherein the pyramidal asperities are oriented in a packed arrangement wherein p value is about 1.

17. A hydrophobic surface as in claim 1 wherein the contact angle increases as the p value increases.

18. A hydrophobic surface as in claim 1 wherein the roughness factor is further characterized by an aspect ratio h/r equal to the height of the asperities h divided by a foundation radius of the asperities r, wherein the aspect ratio h/r has a value of from between about 0.1 to about 10.

19. A hydrophobic surface as in claim 18 wherein the contact angle increases as the aspect ratio increases.

20. A hydrophobic surface as in claim 18 wherein the foundation radius of the asperities are less than the radius of a drop of liquid contacting the surface.
